(19) United States
(12) Patent Application Publication
(10) Pub. No.: US 2021/0119509 A1
(43) Pub. Date: Apr. 22, 2021

(54) MOTOR, RADAR ASSEMBLY, PROPULSION DEVICE, GIMBAL, AND UNMANNED VEHICLE

(71) Applicant: SZ DJI TECHNOLOGY CO., LTD., Shenzhen (CN)

(72) Inventors: Jiadi WANG, Shenzhen (CN); Daoyu WAN, Shenzhen (CN)

(21) Appl. No.: 17/133,862

(22) Filed: Dec. 24, 2020

Related U.S. Application Data
(63) Continuation of application No. PCT/CN2018/093163, filed on Jun. 27, 2018.

(51) Int. Cl. H02K 5/173; B64C 39/02; B64D 27/24; H02K 7/08; H02K 21/22

(52) U.S. Cl. CPC H02K 5/1735; B64C 39/024; B64D 27/24; G01S 13/935; H02K 21/22; B64C 2201/027; B64C 2201/042; H02K 7/085

(57) ABSTRACT

A motor includes a base, a rotor assembly, a first bearing, an elastic member, and a support member. The base includes a body and a support. The body includes a shaft hole. The support is arranged at an inner surface of the shaft hole. The rotor assembly includes a rotation shaft. The bearing is sleeved at the rotation shaft and at least partially mounted in the shaft hole. The rotation shaft is connected to an inner ring of the bearing and configured to rotate relative to an outer ring of the bearing. The elastic member is arranged between the support and the bearing and configured to apply pressure to the outer ring of the bearing. The support member is arranged at the rotation shaft. The support member abuts against the inner ring of the bearing and is configured to provide a support force to the inner ring of the bearing.

### CROSS-REFERENCE TO RELATED APPLICATION

This application is a continuation of International Application No. PCT/CN2018/093163, filed Jun. 27, 2018, the entire content of which is incorporated herein by reference.

### TECHNICAL FIELD

The present disclosure relates to the power driving technology field and, more particularly, to a motor, a radar assembly, a propulsion device, a gimbal, and an unmanned vehicle.

### BACKGROUND

A rotor of a motor rotates and transmits torque with electrical power. The rotor and a stator of the motor are rotatably connected through a bearing. Clearance of the bearing greatly impacts the drive accuracy and operation lifetime of the whole motor. When the motor is being assembled, the clearance can be eliminated by a positioning and pre-tightening manner. However, the positioning and pre-tightening manner requires a worker to adjust a pre-tightening force according to his experience during production, which is not convenient for mass production of motors.

### SUMMARY

Embodiments of the present disclosure provide a motor, including a base, a rotor assembly, a first bearing, an elastic member, and a support member. The base includes a body and a support. The body includes a shaft hole. The support is arranged at an inner surface of the shaft hole. The rotor assembly includes a rotation shaft. The bearing is sleeved at the rotation shaft and at least partially mounted in the shaft hole. The rotation shaft is connected to an inner ring of the bearing and configured to rotate relative to an outer ring of the bearing. The elastic member is arranged between the support and the bearing, and configured to apply pressure to the outer ring of the bearing. The support member is arranged at the rotation shaft. The support member abuts against the inner ring of the bearing and is configured to provide a support force to the inner ring of the bearing. While the motor is operating, the outer ring of the bearing maintains still relative to the base, and the inner ring of the bearing rotates together with the rotation shaft. The support member rotates together with the rotation shaft and prevents the inner ring of the bearing from sliding along an axis direction of the rotation shaft relative to the rotation shaft. The elastic member maintains still relative to the base and provides an elastic force to the outer ring of the bearing to eliminate a clearance of the bearing.

### BRIEF DESCRIPTION OF THE DRAWINGS

FIG. 1 is a schematic structural diagram of an unmanned vehicle according to some embodiments of the present disclosure.

FIG. 2 is a schematic structural diagram of a radar assembly according to some embodiments of the present disclosure.

FIG. 3 is a schematic cross-sectional view of a motor according to some embodiments of the present disclosure.

FIG. 4 is a schematic perspective exploded view of the motor according to some embodiments of the present disclosure.

FIG. 5 is a schematic perspective exploded view of the motor from another view angle according to some embodiments of the present disclosure.

FIG. 6 is a schematic structural diagram of an unmanned vehicle according to some other embodiments of the present disclosure.

### DETAILED DESCRIPTION OF THE EMBODIMENTS

Embodiments of the present disclosure are further described in connection with the accompanying drawings. In the accompanying drawings, same or similar signs represent same or similar elements or elements having same or similar functions.

In addition, embodiments of the present disclosure described in connection with the accompanying drawings are illustrative and are merely used to describe implementations of the present disclosure but cannot be understood to limit the present disclosure.

In the present disclosure, unless otherwise specified or limited, a first feature “on” or “above” a second feature may mean that the first feature and the second feature may have direct contact, or the first feature and the second feature may contact through an intermediate medium. Moreover, the first feature “on,” “above,” or “over” the second feature may mean that the first feature may be directly or obliquely above the second feature, or a horizontal height of the first feature may be higher than a horizontal height of the second feature. The first feature “below,” “under,” or “beneath” the second feature may mean that the first feature is directly or obliquely below the second feature, or the horizontal height of the first feature is lower than the horizontal height of the second feature.

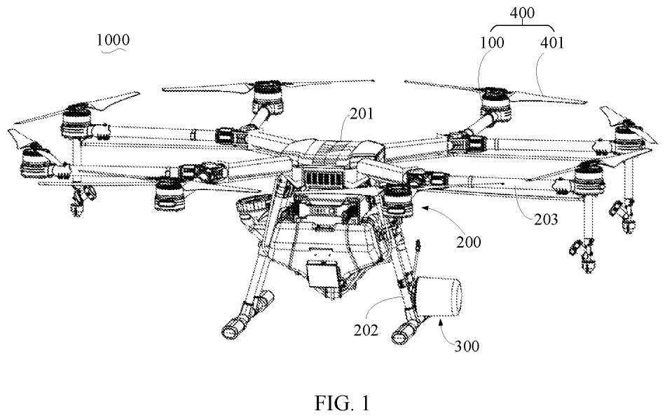

Refer to FIG. 1, an unmanned vehicle 1000 of embodiments of the present disclosure includes a vehicle body 200 and a radar assembly 300. The unmanned vehicle 1000 may include an unmanned aircraft/unmanned aerial vehicle, an unmanned ship, an unmanned car, etc. In this disclosure, an unmanned aircraft/unmanned aerial vehicle is described as an example of the unmanned vehicle 1000. The unmanned vehicle 1000 may also include another form. The unmanned aircraft/unmanned aerial vehicle may include a four-rotor aircraft, a six-rotor aircraft, an eight-rotor aircraft, a sixteen-rotor aircraft, etc.

The vehicle body 200 includes a vehicle frame 201, a stand 202, and a vehicle arm 203. The stand 202 and the vehicle arm 203 are mounted at the vehicle frame 201. The vehicle frame 201 may be configured as a mounting carrier for a flight control system, a processor, and a gimbal of the unmanned vehicle 1000. The stand 202 is mounted under the vehicle frame 201. The stand 202 may be configured to provide support to the vehicle frame 201 after the unmanned vehicle 1000 lands. For example, the stand 202 may be detached from the vehicle frame 201, or the stand 202 may be folded, such that the stand 202 may be conveniently accommodated. The stand 202 may further be configured to carry a water tank to spray and pesticides and nutrient solutions on plants through a spray nozzle. The vehicle arm 203 may be folded or detached. A propulsion device 400 is mounted at the vehicle arm 203.

A radar assembly 300 is mounted at the vehicle body 200. In some embodiments, the radar assembly 300 is mounted at the stand 202 of the vehicle body 200. The radar assembly 300 may also be mounted at the vehicle frame 201 of the vehicle body 200. One or more radar assemblies 300 may be included. For example, a number of the radar assemblies 300 may be two, three, four, etc. A plurality of radar assemblies 300 may be mounted at a front side, a rear side, a left side, a right side, a top side, and/or a bottom side of the vehicle body 200. Refer to FIG. 2, the radar assembly 300 includes a motor 100 and a radar 301.

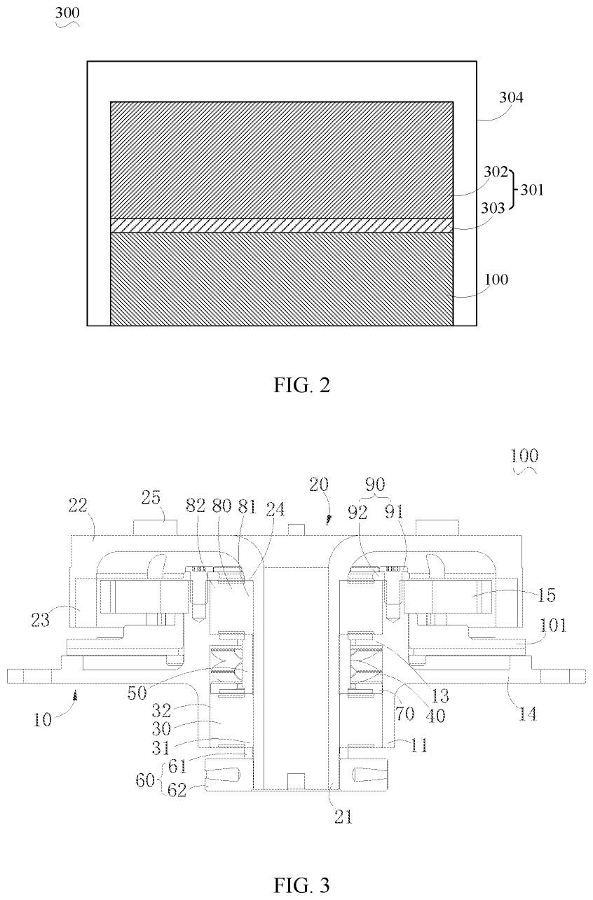

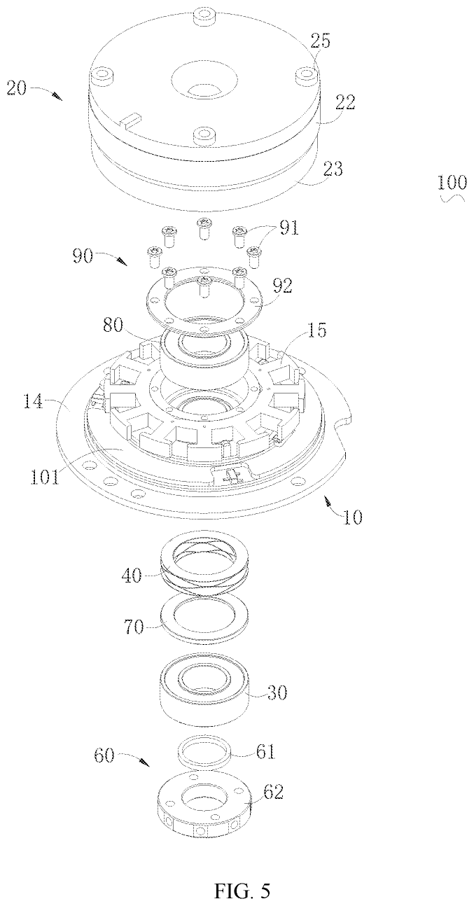

Refer to FIG. 3 to FIG. 5, the motor 100 includes a base 10, a rotor assembly 20, a first bearing 30, an elastic member 40, and a support member 50.

The base 10 includes a body 11, a support 13, and a support plate 14. The base 10 may be configured as a mounting carrier for the elements of the motor 100, such as the rotor assembly 20, the first bearing 30, the elastic member 40, and the support member 50. The body 11 of the base 10 as a whole may have a column-shape, for example, a cylindrical shape. The base 10 includes a shaft hole 12. The shaft hole 12 passes through the body 11. The axis of the shaft hole 12 can coincide with the axis of the body 11.

The support 13 is arranged at the inner surface of the shaft hole 12. In some embodiments, the support 13 extends from the inner surface of the shaft hole 12 toward the center of the shaft hole 12 and does not cover the shaft hole 12. The support 13 is located at the middle of the shaft hole 12, that is, the support 13 is located close to the middle position in the axis direction. The support 13 is not located at two ends of the shaft hole 12. In some embodiments, the support 13 and the body 11 may be formed integrally, for example, by injection molding. In some other embodiments, the support 13 and the body 11 may be formed separately. The support 13 may be welded at the inner surface of the shaft hole 12.

The support plate 14 extends from the body 11 outward. The support plate 14 may be configured to carry a motor control device 101. The support plate 14 extends from the periphery of the body 11 to surrounding. In some embodiments, the support plate 14 may extend from the periphery of the body 11 perpendicularly outward. For example, the motor control device 101 may include a control circuit board. The control circuit board may include functional circuits, such as an electronic speed control (ESC) of the motor 100, a temperature detection circuit of the motor 100, etc., to control the motor 100 to operate normally.

Refer again to FIG. 3 to FIG. 5, the rotor assembly 20 is mounted at the base 10. In some embodiments, the rotor assembly 20 may be rotatably connected to the base 10 through the first bearing 30. The rotor assembly 20 may rotate relative to the base 10. In some embodiments, the motor 100 may include an outer rotor brushless motor. The rotor assembly 20 includes a rotation shaft 21 and a rotor housing 22.

The first bearing 30 may be at least partially mounted in the shaft hole 12. That is, the first bearing 30 may be completely located in the shaft hole 12, or be partially located in the shaft hole 12 and partially located outside the shaft hole 12. The first bearing 30 may be arranged close to an opening end of the shaft hole 12. An outer ring 32 of the first bearing 30 may contact the inner surface of the shaft hole 12. When an axial pressure is applied at the outer ring 32 of the first bearing 30, the outer ring 32 of the first bearing 30 may slide relative to the inner surface of the shaft hole 12. An inner ring 31 of the first bearing 30 may be fixedly connected to the rotation shaft 21. That is, the inner ring 31 of the first bearing 30 may be still relative to the rotation shaft 21, and relative rotation and sliding may not exist between them.

The rotation shaft 21 passes through the inner ring 31 of the first bearing 30 and is connected to the inner ring 31 of the first bearing 30 to arrange and sleeve the inner ring 31 of the first bearing 30 at the rotation shaft 21. When the rotation shaft 21 rotates, the rotation shaft 21 may drive the inner ring 31 of the first bearing 30 to rotate relative to the outer ring 32 of the first bearing 30.

The rotor housing 22 may be fixedly connected to the rotation shaft 21. The rotor housing 22 may rotate with the rotation shaft 21 synchronously. In some embodiments, the rotor housing 22 may be fixed at an end of the rotor shaft away from the first bearing 30. In some embodiments, the rotor housing 22 and the rotation shaft 21 may be formed integrally, for example, through the injection molding. In some other embodiments, the rotor housing 22 and the rotation shaft 21 may be formed separately, and then, the rotor housing 22 and the rotation shaft 21 may be assembled. For example, the rotor housing 22 and the rotation shaft 21 may be assembled by a snap connection or welding. Thus, the rotor housing 22 and the rotation shaft 21 may be made of different materials. For example, the rotor housing 22 may be made of a magnetic conducting material as a part of the yoke of the motor 100, and the rotation shaft 21 may include a support rod made of a non-magnetic conducting material.

In some embodiments, the rotor housing may be approximately in an L shape, which means that the shape of the rotor housing 22 may be obtained by rotating the L shape cross-section of the housing about the rotation shaft 21. A magnet 23 may be arranged at an inner surface of an end of the rotor housing 22. The magnet 23 may be fixed in the rotor housing 22 and may not be seen from the outside of the motor 100. The magnet 23 and a coil 15 of the stator of the motor 100 are arranged opposite to each other at an interval. The coil 15 may generate a magnetic field after being powered on, which may interact with the magnetic field of the magnet 23. The magnet 23 may drive the rotor housing 22 and the rotation shaft 21 to rotate after receiving the interaction force.

A carrier member 25 is arranged outside of the rotor housing 22. The carrier member 25 may be configured to carry external components besides the motor 100. For example, the external components may be fixedly connected to the rotor housing 22 through the carrier member 25. For example, the external components may be fixedly connected to the rotor housing 22 through a threaded connection, a snap connection, etc. When the rotor housing 22 rotates, the carrier member 25 may drive the external components to rotate together.

Refer again to FIG. 3 to FIG. 5, the elastic member 40 is arranged between the support 13 and the first bearing 30. The elastic member 40 is arranged between the support 13 and the outer ring 32 of the first bearing 30. The elastic member 40 may be configured to apply pressure to the outer ring 32 of the first bearing 30. In some embodiments, after the motor is assembled, the elastic member 40 may be in a compression state. Both sides of the elastic member 40 may apply the elastic forces at the support 13 and the outer ring 32 of the first bearing 30, respectively. The elastic member 40 may include at least one of a wave-shape spring or a disc shape spring. For example, the elastic member 40 may include the wave shape spring, or the disc shape spring, or a combination of the wave shape spring and the disc shape spring. The elastic member 40 as a whole may be a ring shape and sleeved at the rotation shaft 21. Thus, the elastic member 40 may not easily fall off, and the elastic force applied by the elastic member 40 at the outer ring 32 of the first bearing 30 may be relatively even at the circumstance of the first bearing 30. The elastic member 40 is arranged in the shaft hole 12. The elastic member 40 and the support plate 14 are arranged opposite to each other relative to the body 11. That is, the elastic member 40 and the support plate 14 are located at two opposite sides of the outer periphery of the body 11, respectively.

A support member 50 is arranged at the rotation shaft 21. The support member 50 abuts against the inner ring 31 of the first bearing 30. The support member 50 may be configured to provide a support force to the inner ring 31 of the first bearing 30. The support member 50 and the inner ring 31 of the first bearing 30, and the support member 50 and the rotation shaft 21 all may rotate together. In some embodiments, the support member 50 as a whole may include a ring-shaped sleeve. The support member 50 may be sleeved at the rotation shaft 21. The support member 50 may be arranged at the middle of the rotation shaft 21. That is, the support member 50 may have a certain distance from both ends of the rotation shaft 21. The support member 50 may be accommodated in the shaft hole 12. The support member 50 may be located between the elastic member 40 and the rotation shaft 21. That is, the elastic member 40 may be sleeved at the support member 50. A clearance may exist between the elastic member 40 and the support member 50. Thus, when the support member 50 is driven by the rotation shaft 21 to rotate, the support member 50 may not have friction with the elastic member 40. The support member 50 and the support 13 may be arranged opposite to each other and spaced apart from each other at a certain predetermined clearance. As such, when the support member 50 is driven by the rotation shaft 21 to rotate, the support member 50 may not have friction with the support 13.

When the motor 100 is in operation, the rotation shaft 21 may rotate, the outer ring 32 of the first bearing 30 may maintain still relative to the base 10, and the inner ring 31 of the first bearing 30 may rotate together with the rotation shaft 21. Meanwhile, the support member 50 may rotate together with the rotation shaft 21, and the support member 50 may prevent the inner ring 31 of the first bearing 30 from sliding along the axial direction of the rotation shaft 21 relative to the rotation shaft 21. The elastic member 40 may maintain still relative to the base 10 and may provide an elastic force to the outer ring 32 of the first bearing 30 to eliminate the clearance of the first bearing 30.

Refer to FIG. 2 and FIG. 3, the radar 301 is mounted at the rotor assembly 20. In some embodiments, the radar 301 is mounted at the rotor housing 22 of the rotor assembly 20. In some embodiments, the radar 301 may be mounted at the rotor housing 22 through the carrier member 25. The radar 301 includes a radar body 302 and a radar base 303. The radar body 302 is mounted at the radar base 303. The radar base 303 may be mounted at the rotor housing 22 through the carrier member 25. When the rotor assembly 20 rotates, the rotor assembly 20 may drive the radar base 303 to rotate. The radar base 303 may then drive the radar body 302 to rotate. The radar body 302 may transmit an electromagnetic wave signal (e.g., microwave signal) and receive the electromagnetic wave signal reflected back by an external object. Since the radar body 302 may be driven by the radar base 303 to rotate, the radar body 302 may transmit the electromagnetic wave signal to a plurality of directions, and receive the electromagnetic wave signal reflected back in the plurality of directions to detect obstacles in the plurality of directions, and a plurality of one-way transmission radars may not need to be arranged. In an example shown in FIG. 2, the radar assembly 300 includes a radar cover 304. The radar cover 304 may cover the radar 301 and the motor 100.

The base 10 of the motor 100 and the radar base 303 may be arranged separately. When the base 10 is damaged, the base 10 may be repaired individually or replaced, and when the radar base 303 is damaged, the radar base 303 may be repaired individually and replaced. As such, later maintenance may be convenient. Since the base 10 of the motor 100 and the radar base 303 are arranged separately, the motor 100 with a larger size may be arranged when the radar assembly 300 has the same size in the radial direction. Therefore, larger bearings may be selected for the first bearing 30 and a second bearing 80. The reliability of the first bearing 30 and the second bearing 80 may be improved.

In summary, in the unmanned vehicle 1000 of embodiments of the present disclosure, the inner ring 31 of the first bearing 30 of the motor 100 may rotate together with the rotation shaft 21. The elastic member 40 may maintain still relative to the base 10 and apply the pressure to the outer ring 32 of the first bearing 30 to eliminate the clearance of the first bearing 30. The elastic member 40 may apply the pressure to the outer ring 32 of the first bearing 30 as soon as after being mounted, and the pre-tightening force may not need to be adjusted manually, which may facilitate automatic production and mass production of the motor 100.

Refer to FIG. 3, in some embodiments, the rotation shaft 21 may be connected to the inner ring 31 of the first bearing 30 by an interference fit. When the rotation shaft 21 and the first bearing 30 are assembled, glue may not need to be applied to the inner surface of the inner ring 31 of the first bearing 30 to prevent the glue from entering the balls and the cage of the first bearing 30. Thus, the assembly may be convenient, and the efficiency of the assembly may be high.

In some embodiments, a ratio of the pressure applied by the elastic member 40 to the outer ring 32 of the first bearing 30 and dynamic load of the first bearing 30 may be in a range of [0.01, 0.03]. In some embodiments, the ratio may be any value in the above range, such as 0.01, 0.015, 0.02, 0.023, or 0.03. When the ratio is in the above range, the outer ring 32 of the first bearing 30 and the inner ring 31 of the first bearing 30 may well contact the balls of the first bearing 30, and the pre-tightening force between the outer ring 32 of the first bearing 30 and the balls of the first bearing 30 and the inner ring 31 of the first bearing 30 and the balls of the first bearing 30 may not be too large and may not cause too fast wear. The dynamic load of the first bearing 30 may refer to the basic axial rated dynamic load of the first bearing 30.

Refer again to FIG. 3 to FIG. 5, in some embodiments, the motor 100 further includes a gasket 70. The gasket 70 is arranged between the elastic member and the first bearing 30. The two opposite sides of the gasket 70 abut against the elastic member 40 and the outer ring 32 of the first bearing 30, respectively. The elastic force of the elastic member 40 may directly be applied to the gasket 70. Then, the gasket 70 may transfer the elastic force to the outer ring 32 of the first bearing 30. In some embodiments, a contact area between the gasket 70 and the outer ring 32 of the first bearing may be smaller than a contact area between the gasket 70 and the elastic member 40. The gasket 70 may only abut against the outer ring 32 of the first bearing 30 but may not contact the balls and the cage of the first bearing 30.

In some embodiments, the gasket 70 is accommodated in the shaft hole 12. The gasket as a whole may have a ring shape. The gasket 70 may be sleeved at the support member 50. The gasket 70 and the support member 50 may be arranged at an interval. When the rotor assembly 20 and the support member 50 rotate, the gasket 70 may maintain still relative to the base 10.

Refer to FIG. 3 to FIG. 5, in some embodiments, the motor 100 further includes a lock assembly 60. The lock assembly 60 is fixedly mounted at the rotation shaft 21. The lock assembly 60 and the support member 50 abut against the two axial sides of the inner ring 31 of the first bearing 30, respectively. The lock assembly 60 and the support member 50 may together fix the inner ring 31 of the first bearing 30 relative to the rotation shaft 21.

As shown in FIG. 3 to FIG. 5, the lock assembly 60 includes a washer 61 and a locking crew nut 62. The washer 61 is sleeved at the rotation shaft 21. One side of the washer 61 abuts against the inner ring 31 of the first bearing 30. The locking screw nut 62 is mounted at the rotation shaft 21. The locking screw nut 62 abuts against the other side of the washer 61. The washer 61 is a ring shape. The washer 61 abuts against the inner ring 31 of the first bearing 30 and does not cover the balls of the first bearing 30. Therefore, the rotation of the balls of the first bearing 30 may not be affected, and the heat of the first bearing 30 may be well dissipated. The locking screw nut 62 may be connected to the rotation shaft 21 by a thread. The locking screw nut may include a screw nut having a hole at the side surface. The locking screw nut 62 and the washer 61 may be formed integrally.

In some other embodiments, the lock assembly 60 may not include the washer 61. The lock assembly 60 may include the locking screw nut 62. After the locking screw nut 62 is mounted at the rotation shaft 21, the locking screw nut 62 may abut against the inner ring 31 of the first bearing 30 to fix the inner ring 31 of the first bearing 30 relative to the rotation shaft 21 together with the support member 50.

Refer again to FIG. 3 to FIG. 5, in some embodiments, the motor 100 further includes the second bearing 80. The inner ring 81 of the second bearing 80 is sleeved at the rotation shaft 21 and is fixedly connected to the rotation shaft 21. The support member 50 abuts against the inner ring 81 of the second bearing 80. The support member 50 may be configured to provide a support force at the inner ring 81 of the second bearing 80. The outer ring 82 of the second bearing 80 abuts against the support 13.

The rotation shaft 21 is arranged and passes through the first bearing 30 and the second bearing 80, and the stability of the rotation shaft 21 is better during the rotation. The inner ring 81 of the second bearing 80 may be fixedly connected to the rotation shaft 21 and may rotate with the rotation shaft 21 synchronously. The rotation shaft 21 may be combined with the inner ring 81 of the second bearing 80 by an interference fit. When the rotation shaft 21 and the second bearing 80 are assembled, glue may not need to be applied to the inner surface of the inner ring 81 of the second bearing 80. Thus, the glue may be prevented from entering the balls of the second bearing 80, which may facilitate the assembly, and the efficiency of the assembly may be high. The outer ring 82 of the second bearing 80 contacts the inner surface of the shaft hole 12. The outer ring 82 of the second bearing 80 may be still relative to the base 10.

Refer to FIG. 3, in some embodiments, a shaft shoulder 24 is formed at the position where the rotor housing 22 and the rotation shaft 21 are connected. The shaft shoulder 24 and the support member 50 abut against the two axial sides of the inner ring 81 of the second bearing 80, respectively. As such, the inner ring 81 of the second bearing 80 may not slide axially relative to the rotation shaft 21.

Refer to FIG. 3 to FIG. 5, in some embodiments, the motor 100 further includes a compression assembly 90. The compression assembly 90 is fixedly mounted at the body 11. The compression assembly 90 abuts against a side of the outer ring 82 of the second bearing 80. The support 13 abuts against the other side of the outer ring 82 of the second bearing 80 to position the outer ring 82 of the second bearing 80. The compression assembly 90 and the support 13 clamp the outer ring 82 of the second bearing 80. The outer ring 82 of the second bearing 80 may not jump along the axial direction of the shaft hole 12. Thus, noise may be small during the operation of the motor 100.

For example, as shown in FIG. 3, the clearance of the second bearing 80 may be eliminated through the following manners. The elastic member 40 may apply the elastic force at the outer ring 32 of the first bearing 30 through the gasket 70. The outer ring 32 of the first bearing 30 may move downward and apply the force at the inner ring 31 of the first bearing 30 downward. The downward force applied at the inner ring 31 of the first bearing 30 may be transferred to the inner ring 81 of the second bearing 80 through the rotation shaft 21. That is, the inner ring 81 of the second bearing 80 may also move downward. Since the outer ring 82 of the second bearing 80 is fixed, the inner ring 81 of the second bearing 80 may move downward relative to the outer ring 82 of the second bearing 80, and the clearance of the second bearing 80 may be eliminated.

Refer to FIG. 3 to FIG. 5, in some embodiments, the compression assembly 90 includes a compression member 92 and a fastening member 91. The fastening member 91 is fixedly connected to the body 11 to fix the compression member 92 at the body 11. The compression member 92 abuts against the outer ring 82 of the second bearing 80. In some embodiments, the compression member 92 is a ring shape. The compression member 92 is sleeved at the rotation shaft 21. A predetermined gap may exist between the inner periphery of the compression member 92 and the rotation shaft 21. Thus, the compression member 92 may not block the rotation of the rotation shaft 21.

The compression member 92 is fixed at the end surface of the opening end of the shaft hole 12 of the body 11. In some embodiments, a plurality of screw holes may be arranged around the shaft hole 12 at the end surface. A plurality of through-holes may be arranged at the compression member 92 corresponding to the plurality of screw holes. The fastening member 91 may include a screw. The fastening member 91 may cooperate with the screw hole and fix the compression member 92 at the body 11. The plurality of screw holes may be evenly distributed along the circumstance of the shaft hole 12 at intervals. A portion of the compression member 92 may compress the end surface tightly, the other portion of the compression member 92 may abut against the outer ring 82 of the second bearing 80. In some embodiments, the compression member 92 may be a disc shape to reduce the overall thickness of the compression assembly 90.

In some other embodiments, the compression assembly 90 may not include the compression member 92. The compression assembly 90 may include the fastening member 91. The fastening member 91 may be fixedly mounted at the body 11 and may directly abut against the outer ring of the second bearing 80.

Refer to FIG. 3, in some embodiments, an outer diameter of the first bearing 30 is the same as an outer diameter of the second bearing 80. As such, the size of the shaft hole 12 may be uniform, and the shaft hole 12 may be easy to form by a mold.

An inner diameter of the first bearing 30 may be the same as an inner diameter of the second bearing 80. As such, a size of an outer diameter of the rotation shaft 21 may be uniform, which is easy to process to form the rotation shaft 21.

The first bearing 30 and the second bearing 80 may be of a same model. As such, the first bearing 30 and the second bearing 80 may be interchangeably used and have a consistent application lifetime.

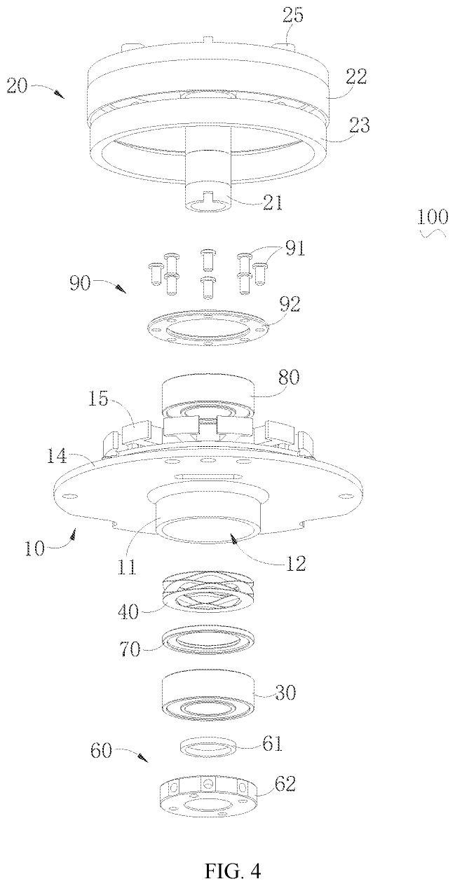

One of the mounting manners of the motor 100 of embodiments of the present disclosure is described in connection with FIG. 3 and FIG. 4. The second bearing 80 may be mounted in the shaft hole 12 from an end of the shaft hole 12 first. The outer ring 82 of the second bearing 80 abuts against the support 13. Then, the compression assembly 90 may be mounted to fix the outer ring 82 of the second bearing 80. Then, the rotation shaft 21 may be connected to the second bearing 80 by the interference fit. Next, the support member 50, the elastic member 40, and the gasket 70 may be sleeved at the rotation shaft 21 from the other end. Next, the first bearing 30 may be sleeved at the rotation shaft 21 to make the inner ring 31 of the first bearing 30 and the rotation shaft 21 interference fit and the outer ring 32 of the first bearing 30 to abut against the gasket 70. Finally, the lock assembly 60 may be fixed at the rotation shaft 21 to cause the lock assembly 60 and the support member 50 to abut against both sides of the inner ring 31 of the first bearing 30.

Refer to FIG. 1 and FIG. 3, in some embodiments, the motor 100 of any of embodiments above is applied in a propulsion device 400. The propulsion device 400 includes the motor 100 and a propeller 401. The propeller 401 is mounted at the rotor assembly 20. The rotor assembly 20 may rotate to drive the propeller 401 to rotate. The propulsion device 400 may be mounted at the vehicle body 200. In some embodiments, the propulsion device 400 is mounted at the vehicle arm 203 of the vehicle body 200. The propeller 401 may be mounted at the carrier member 25 of the rotor assembly 20. The propeller 401 may be driven to rotate to provide power for the unmanned vehicle 1000.

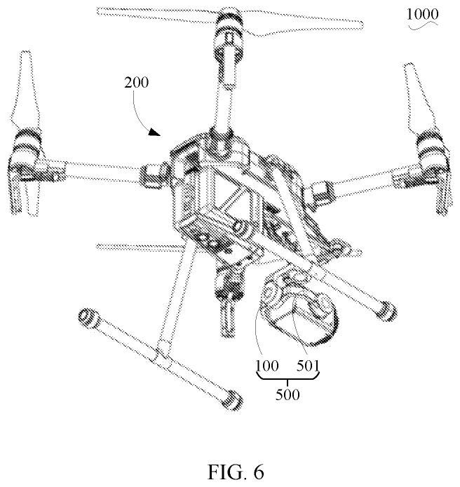

Refer to FIG. 3 and FIG. 6, in some embodiments, the motor 100 of any of embodiments above is applied in a gimbal 500. The gimbal 500 includes a plurality of connection arms 501. The motor 100 is connected to the connection arms 501 to drive the connection arms 501 to rotate. For example, the base 10 of the motor 100 is connected to a connection arm 501. The rotor assembly 20 of the motor 100 is connected to another connection arm 501. When the rotor assembly 20 is driven to rotate, the rotor assembly 20 may drive the two connection arms 501 to rotate relative to each other. The gimbal 500 may include a handheld gimbal or a gimbal carried by a machine, for example, the gimbal 500 is carried by the unmanned vehicle 1000, and the gimbal 500 may be mounted at the vehicle body 200 of the unmanned vehicle 1000.

In the description of this specification, the description of reference terms of “certain embodiments,” “one embodiment,” “some embodiments,” “examples,” “specific examples,” or “some examples,” is intended to incorporate the specific features, structures, materials, or characteristics described in embodiments or examples to be included in at least one embodiment or example of the present disclosure. In this specification, the schematic description of the above terms is not necessarily for a same embodiment or example. Moreover, the described specific features, structures, materials, or characteristics may be combined in any one or more embodiments or examples in a suitable manner. In addition, those skilled in the art may combine and group different embodiments or examples and features of different embodiments or examples described in this specification when there is no conflict.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “plurality” means at least two, for example, two or three, unless otherwise specified. Although embodiments of the present disclosure are shown and described above, the above embodiments are exemplary and should not be understood as limitations of the present disclosure. Those of ordinary skill in the art may perform modification, change, replacement, and variation on embodiments above within the scope of the present disclosure. The scope of the present invention is defined by the claims and their equivalents.

What is claimed is:

1. A motor comprising:
a base including:
a body including a shaft hole; and
a support arranged at an inner surface of the shaft hole;
a rotor assembly including a rotation shaft;
a bearing sleeved at the rotation shaft and at least partially mounted in the shaft hole, the rotation shaft being connected to an inner ring of the bearing and configured to rotate relative to an outer ring of the bearing;
an elastic member arranged between the support and the bearing, and configured to apply pressure to the outer ring of the bearing; and
a support member arranged at the rotation shaft, the support member abutting against the inner ring of the bearing and being configured to provide a support force to the inner ring of the bearing;
wherein while the motor is operating:
the outer ring of the bearing maintains still relative to the base, and the inner ring of the bearing rotates together with the rotation shaft;
the support member rotates together with the rotation shaft and prevents the inner ring of the bearing from sliding along an axis direction of the rotation shaft relative to the rotation shaft; and
the elastic member maintains still relative to the base and provides an elastic force to the outer ring of the bearing to eliminate a clearance of the bearing.

2. The motor of claim 1, wherein the motor is an outer rotor brushless motor.

3. The motor of claim 1, wherein the support member is sleeved at the rotation shaft and configured to rotate together with the rotation shaft.

4. The motor of claim 1, further comprising:
a lock assembly fixedly mounted at the rotation shaft;
wherein the lock assembly and the support member abut against two axial sides of the inner ring of the bearing, respectively.

5. The motor of claim 4, wherein:
the lock assembly includes a locking screw nut mounted at the rotation shaft and abutting against the inner ring of the bearing.

6. The motor of claim 4, wherein the lock assembly includes:
a washer sleeved at the rotation shaft, one side of the washer abutting against the inner ring of the bearing; and
a locking screw nut mounted at the rotation shaft and abutting against another side of the washer.

7. The motor of claim 1, further comprising:
a gasket arranged between the elastic member and the bearing, two opposite sides of the gasket abut against the elastic member and the outer ring of the bearing, respectively.

8. The motor of claim 7, wherein the gasket is accommodated in the shaft hole and is sleeved at the support member.

9. The motor of claim 1, wherein the rotation shaft and the inner ring of the bearing are connected to each other by an interference fit.

10. The motor of claim 1, wherein the elastic member includes at least one of a wave shape spring or a disc shape spring.

11. The motor of claim 1, wherein the elastic member is accommodated in the shaft hole and is sleeved at the support member.

12. The motor of claim 1, wherein:
the support is located at middle of the shaft hole; and
the support and the body are formed integrally.

13. The motor of claim 1, wherein the support member is arranged at middle of the rotation shaft.

14. The motor of claim 1, wherein:
the support member and the support are arranged opposite to each other; and
the support and the support member are spaced apart from each other at a predetermined clearance.

15. The motor of claim 1, wherein the bearing is arranged close to an opening end of the shaft hole.

16. The motor of claim 1, wherein the base further includes a support plate extending from the body outward and configured to carry a motor control device.
